(19) United States
(12) Patent Application Publication
(10) Pub. No.: US 2015/0180036 A1
(43) Pub. Date: Jun. 25, 2015

(54) NONAQUEOUS ELECTROLYTE SECONDARY BATTERY

(71) Applicant: TOYOTA JIDOSHA KABUSHIKI KAISHA, Toyota-shi, Aichi-ken (JP)

(72) Inventor: Yoshitomo Takebayashi, Toyota-shi (JP)

(73) Assignee: TOYOTA JIDOSHA KABUSHIKI KAISHA, Toyota-shi, Aichi-ken (JP)

(21) Appl. No.: 14/418,745

(22) PCT Filed: Oct. 24, 2013
(86) PCT No.: PCT/IB2013/002373

§ 371 Date: Jan. 30, 2015

(30) Foreign Application Priority Data
Oct. 26, 2012 (JP) 2012-236325
Aug. 12, 2013 (JP) 2013-167283

(51) Int. Cl. H01M 4/62; H01M 10/052; H01M 4/525; H01M 4/131; H01M 4/505

(52) U.S. Cl. CPC H01M 4/62; H01M 4/131; H01M 4/505; H01M 4/525; H01M 10/052

(57) ABSTRACT

A nonaqueous electrolyte secondary battery includes: a positive electrode having a positive electrode mixture layer, a negative electrode, and a nonaqueous electrolyte. The positive electrode mixture layer includes a positive electrode active material (1) and an inorganic phosphate. The inorganic phosphate is at least one of a phosphate and a pyrophosphate and includes at least one of alkali metals and second group elements.

### BACKGROUND OF THE INVENTION

1. Field of the Invention

The invention relates to a nonaqueous electrolyte secondary battery.

2. Description of Related Art

A lithium ion secondary battery is one of nonaqueous electrolyte secondary batteries. The lithium ion secondary battery is a secondary battery that can be charged and discharged by the movement of lithium ions in a nonaqueous electrolyte between a positive electrode and a negative electrode. Each of the positive electrode and the negative electrode stores and releases lithium ions.

Japanese Patent Application Publication No. 2003-173770 (JP 2003-173770 A) describes a technique for inhibiting the reaction between an electrolytic solution and a positive electrode in a high-potential state by coating the surface of a positive electrode active material with a lithium ion conducting member.

With the technique described in JP 2003-173770 A, it is possible to prevent self-discharge, protect the battery from bulging during storage at a high temperature, and obtain a battery that excels in charge-discharge performance. However, the coating formed on the surface of the active material in such a battery can increase the battery resistance. There is a possibility that the voltage is decreased and a battery having the desired operation range cannot be obtained.

### SUMMARY OF THE INVENTION

The invention provides a nonaqueous electrolyte secondary battery that operates at a high voltage while having high durability.

A nonaqueous electrolyte secondary battery according to an aspect of the invention includes a positive electrode having a positive electrode mixture layer, a negative electrode, and a nonaqueous electrolyte. The positive electrode mixture layer includes a positive electrode active material and an inorganic phosphate. The inorganic phosphate is at least one of a phosphate and a pyrophosphate including a metal. The metal is at least one of alkali metals and second group elements. The positive electrode may have a region with an open-circuit voltage equal to or higher than 4.3 V (Li/Li⁺) in the operation range of the battery.

The inorganic phosphate may be a phosphate including one of the alkali metals and the second group elements. The phosphate may be Li₃PO₄. Further, the one of the alkali metals and the second group elements may be an element belonging to one of the third period and fourth period. The phosphate may be Na₃PO₄. The inorganic phosphate may be Li_{1.5}Al_{0.5}Ge_{1.5}(PO₄)₃.

The ratio of the inorganic phosphate to the positive electrode active material may be 0.5 wt % to 10 wt %, or 1.0 wt % to 5.0 wt %, or 1.0 wt % to 3.0 wt %.

The positive electrode active material may be a NiMn spinel-system positive electrode active material. The NiMn spinel-system positive electrode active material may be LiNi_{0.5}Mn_{1.5}O₄. The positive electrode mixture layer may include solid electrolyte particles of the inorganic phosphate.

According to the aspect of the invention, it is possible to provide a nonaqueous electrolyte secondary battery that operates at a high voltage while having high durability.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 illustrates a positive electrode mixture according to an embodiment;

FIG. 2 illustrates a positive electrode mixture as an object for comparison;

FIG. 3 is a graph illustrating the relationship between the mixed amount of the electrolyte material and a capacity retention ratio; and

FIG. 4 is a graph illustrating the relationship between the electrolyte material, capacity retention ratio, and elution ratio.

### DETAILED DESCRIPTION OF EMBODIMENTS

The first embodiment will be briefly explained below. The nonaqueous electrolyte secondary battery (can be referred to hereinbelow as “battery”) of the embodiment is a lithium ion secondary battery including a positive electrode having a positive electrode mixture layer and a positive electrode collector, a negative electrode, and a nonaqueous electrolyte. The positive electrode preferably has a region with an open-circuit voltage equal to or higher than 4.3 V (Li/Li⁺) in an operation range of the nonaqueous electrolyte secondary battery.

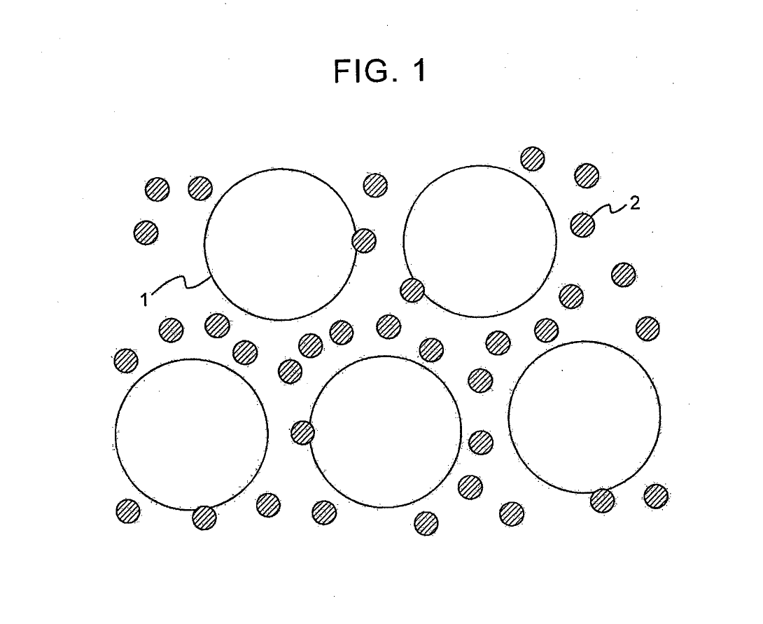

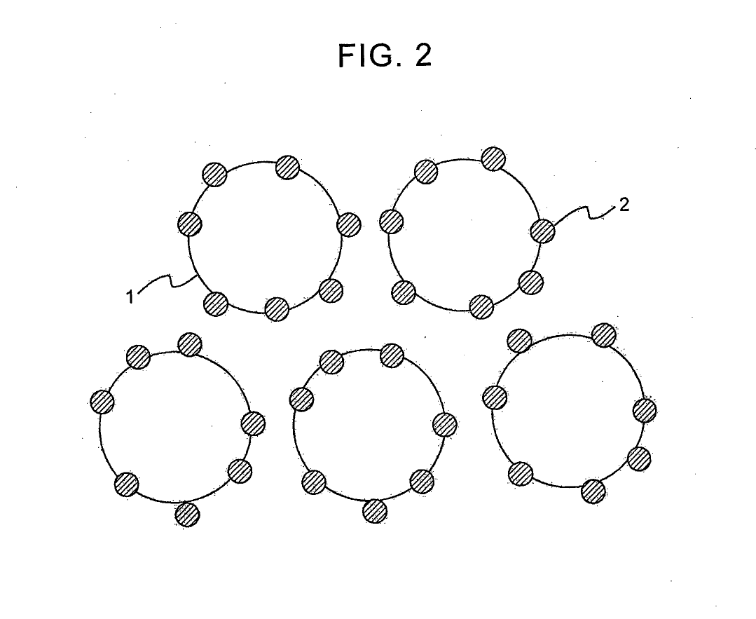

As shown in FIG. 1 or 2, the positive electrode mixture layer preferably includes a positive electrode active material 1 and an inorganic phosphate. As shown in FIG. 1 or 2, the inorganic phosphate may be in the form of specific electrolyte particles as in the below-described second embodiment, but the inorganic phosphate in accordance with the invention is not limited to the inorganic phosphate of the second embodiment.

It is preferred than the inorganic phosphate be mixed as an electrolyte material with an active material substance to obtain a positive electrode mixture. When mixed in the positive electrode mixture, as mentioned hereinabove, the inorganic phosphate functions as an acid-consuming material and reacts with the acid contained in the electrolytic solution.

The acid is generated by oxidation and decomposition of the electrolytic solution on the surface of the high-potential positive electrode. The acid may also cause the elution of a transition metal of the positive electrode active material. Therefore, in batteries with a high open-circuit voltage, the capacity tends to be degraded.

In the embodiment, the inorganic phosphate prevents the elution of transition metal from the positive electrode active material and prevents the battery from degradation during the use of the battery. The battery excels in durability while the battery including such an inorganic phosphate has a high voltage. The use of the battery includes charging and discharging of the battery.

The positive electrode active material 1 is not particularly limited, but a NiMn spinel-system positive electrode active material is preferred and LiNi_{0.5}Mn_{1.5}O₄ is especially preferred.

In order to improve durability of the battery by preventing the positive electrode active material from degradation, it is preferred that the inorganic phosphate be a phosphate and/or a pyrophosphate including a phosphoric acid ion (PO₄³⁻), and even more preferred that the inorganic phosphate include a (predetermined) metal. Such an inorganic phosphate has high voltage resistance and, therefore, stably functions as an acid-consuming material even at the open-circuit voltage of the battery of the embodiment.

The metal in the inorganic phosphate is preferably an alkali metal and/or a second group element. Since such an inorganic phosphate has high reactivity with acids, it is suitable for mixing into the positive electrode mixture. The inorganic phosphate traps the acid generated during the use of the battery. As a result, the elution of metal from the positive electrode active material is reduced.

The metal is preferably one or more metals selected from a group consisting of lithium (Li), sodium (Na), potassium (K), magnesium (Mg), and calcium (Ca). The metal is preferably one or more metals selected from a group consisting of Li, Na, Mg, and Ca. The metal is preferably Li and/or Na. The metal may be an alkaline earth metal.

Examples of such inorganic phosphates include lithium phosphate (Li₃PO₄) and lithium aluminum germanium phosphate (LAGP; Li_{1.5}Al_{0.5}Ge_{1.5}(PO₄)₃). Thus, as represented by LAGP a metal or an element other than the alkali metal and/or second group element may be included.

The inorganic phosphate is preferably a phosphate including a metal ion, such as represented by M₃PO₄ (M is an alkali metal) or M₃(PO₄)₂ (M is a second group element). The inorganic phosphate is preferably a pyrophosphate including a metal ion, such as represented by M₄P₂O₇ (M is an alkali metal) or M₂P₂O₇ (M is a second group element). The alkali metal or the second group element may belong to the third period or fourth period.

Examples of such phosphates include lithium phosphate (Li₃PO₄), dilithium sodium phosphate (Li₂NaPO₄), and sodium magnesium phosphate (MgNaPO₄). Examples of such pyrophosphate include lithium pyrophosphate (Li₄P₂O₇), sodium pyrophosphate (Na₄P₂O₇), potassium pyrophosphate (K₄P₂O₇), magnesium pyrophosphate (Mg₂P₂O₇), and calcium pyrophosphate (Ca₂P₂O₇).

The inorganic phosphate is preferably a phosphate of an alkali metal or a second group element. The preferred examples of such phosphates include lithium phosphate (Li₃PO₄), sodium phosphate (Na₃PO₄), potassium phosphate (K₃PO₄), magnesium phosphate (Mg(PO₄)₂), and calcium phosphate (Ca₃(PO₄)₂).

From the standpoint of preventing the elution of metal from the active material and retaining the capacity, it is more preferred that the inorganic phosphate be Li₃PO₄ and/or Na₃PO₄, and Li₃PO₄ is even more preferred. The battery including such inorganic lithium salts demonstrates a high level of prevention of metal elution from the active material and retention of battery capacity.

The positive electrode mixture layer of the embodiment includes the inorganic phosphate at a ratio preferably equal to or less than 10.0 wt %, more preferably 0.5 wt % to 10.0 wt %, even more preferably 1.0 wt % to 5.0 wt %, and particularly preferably 1.0 wt % to 3.0 wt % with respect to the positive electrode active material.

Where the content of the inorganic phosphate in the positive electrode of the abovementioned structure is within the above-mentioned range, durability can be improved while inhibiting the increase in electric resistance even when the positive electrode is a high-potential electrode.

For example, carbon black such as acetylene black (AB), Ketjen black (registered trade name) and graphite may be used as the electrically conductive material.

For example, polyvinylidene fluoride (PVDF), styrene-butadiene rubber (SBR), polytetrafluoroethylene (PTFE), and carboxymethyl cellulose (CMC) may be used as the binder. From the standpoint of improving the durability of the positive electrode, a non-electrolytic binder is preferred, and PVDF is particularly preferred.

When PVDF is used as the binder for the positive electrode, an organic solvent is preferred as a solvent for the positive electrode. An aprotic polar solvent is further preferred. For example, N-methyl-2-pyrrolidone (NMP) may be advantageously used. By using the solvent as a dispersant, it is possible to disperse the positive electrode material rapidly in the positive electrode mixture.

The positive electrode mixture is prepared by kneading, as appropriate, the active material, electrolyte material, electrically conductive material, and binder. The positive electrode for the lithium ion secondary battery is prepared by coating the positive electrode mixture fabricated in the above-described manner on a positive electrode collector and drying. Aluminum or an alloy containing aluminum as the main component may be used as the positive electrode collector.

The negative electrode of the lithium ion secondary battery has a negative electrode active material. The negative electrode active material is a material that can store and release lithium. For example, a particulate carbon material constituted by graphite or the like, or an amorphous carbon-coated natural graphite obtained by coating natural graphite with amorphous carbon may be used.

The negative electrode is prepared similarly to the positive electrode by kneading the negative electrode active material, a solvent, and a binder, coating the negative electrode mixture obtained by kneading on a negative electrode collector, and drying. When SBR is used as the binder, it is preferred that water be used as the solvent. For example, copper or nickel or alloys thereof may be used for the negative electrode collector.

The nonaqueous electrolytic solution is a composition in which a support salt is contained in a nonaqueous solvent. The nonaqueous solvent is preferably an organic electrolyte. One, or two or more materials selected from the group consisting of fluorine-containing solvents, propylene carbonate (PC), ethylene carbonate (EC), diethyl carbonate (DEC), dimethyl carbonate (DMC), and ethyl methyl carbonate (EMC) may be used as the nonaqueous solvent.

In the embodiment, a fluorine-containing solvent is preferred. Fluorinated carbonic acid esters are preferred as the fluorine-containing solvent. Monofluoroethylene carbonate (MFEC) (carbonic acid, methyl 2,2,2-trifluoroethyl ester; CAS 156783-95-8) and/or difluorinated dimethyl carbonate (DFDMC) is preferred as the fluorinated carbonic acid ester. It is particularly preferred that such carbonates be mixed at a volume ratio of 50:50.

When such a solvent is selected as the nonaqueous electrolytic solution, high resistance to oxidation is achieved. Therefore, such a nonaqueous electrolytic solution can be combined with the above-mentioned high-potential electrode. Such solvents tend to generate acid by thermal decomposition, but this problem can be resolved by using the abovementioned acid-consuming material. By configuring the positive electrode in the above-described manner it is possible to improve the durability of the battery while maintaining a high electrode potential.

One, or two or more lithium compounds (lithium salts) selected from, for example, LiPF₆, LiBF₄, LiClO₄, LiAsF₆, LiCF₃SO₃, LiC₄F₉SO₃, LiN(CF₃SO₂)₂, LiC(CF₃SO₂)₃, and LiI may be used as the support salt. From the standpoint of durability and improving the battery voltage, LiPF₆ is preferred.

The lithium ion secondary battery in accordance with the invention may be provided with a separator. A porous polymer membrane such as a porous polyethylene membrane (PE), a porous polypropylene membrane (PP), a porous polyolefin membrane, and a porous poly(vinyl chloride) membrane is preferred as the separator.

Further, a lithium-ion-polymer electrolyte membrane or an ion-conductive polymer electrolyte membrane is also preferred as the separator. Such membranes may be used individually or in combinations. From the standpoint of increasing the battery output, a three-layer coat separator in which PE is sandwiched between two layers (upper and lower) of PP is preferred.

A lithium ion secondary battery equipped with a wound electrode body will be explained hereinbelow by way of example. The wound electrode body is formed by laminating an elongated positive electrode sheet (positive electrode) and an elongated negative electrode sheet (negative electrode), with an elongated separator interposed therebetween, winding the laminate, and compressing the obtained wound body from the side surface direction.

In this case, the positive electrode sheet has a structure in which a positive electrode mixture layer including a positive electrode active material is supported on each surface of the foil-shaped positive electrode collector. Similarly to the positive electrode sheet, the negative electrode sheet has a structure in which a negative electrode active material is supported on each surface of the foil-shaped negative electrode collector.

A conventional case may be used for the lithium ion secondary battery. The secondary batteries can be of a cylindrical, coin, angular, or film (laminate) shape, and the battery case may be selected according to the desired battery type.

The angular battery preferably includes a case main body in the form of a flat rectangular parallelepiped with an opened upper end and a lid closing the opening. A metal material such as aluminum and steel is preferred for the case. In other embodiments, the case may be molded from a resin material such as a polyphenylene sulfide resin (PPS) or a polyimide resin.

A positive electrode terminal for electric connection to the positive electrode of the wound electrode body and a negative electrode terminal for electric connection to the negative electrode of the wound electrode body are provided on the upper surface (that is, the lid) of the case. A positive electrode lead terminal and a negative electrode lead terminal are provided in predetermined portions of the wound electrode body and electrically connected to the aforementioned positive electrode terminal and negative electrode terminal, respectively.

Those predetermined portions are preferably the exposed portions of the positive electrode sheet and negative electrode sheet at both ends of the wound electrode body. In one embodiment, those portions are portions where the positive electrode mixture layer and the negative electrode mixture layer are not present.

The wound electrode body designed and fabricated in the above-described manner is accommodated in the case main body, and the opening of the case main body is sealed using the lid. Then, the nonaqueous electrolytic solution is poured in through a pouring hole provide in the lid, and the pouring hole is sealed with a sealing cap, thereby fabricating the lithium ion secondary battery according to the embodiment.

The lithium ion secondary battery fabricated by the above-described method is subjected to the conditioning treatment. The conditioning treatment is implemented by repeatedly charging and discharging the lithium ion secondary battery a predetermined number of times. The charge rate, discharge rate and set voltages for charging and discharging during the implementation of the conditioning treatment may be set at random.

In the embodiment, a phosphate is mixed as an acid-consuming material into the mixture of a high-potential positive electrode. Since the acid-consuming material consumes the acid present in the electrolytic solution, the elution of a transition metal by the acid in the high-potential positive electrode can be inhibited. In the embodiment, it is possible to provide a lithium secondary battery that has high durability while operating at a high voltage.

The second embodiment will be briefly explained below. The explanation of the nonaqueous electrolyte secondary battery of the embodiment is focused on the differences with the first embodiment. The explanation of the features common with the first embodiment is omitted.

FIG. 1 shows a positive electrode mixture layer of the embodiment. As shown in FIG. 1, the positive electrode mixture layer preferably includes a positive electrode active material 1 and electrolyte particles 2 which are phosphate solid electrolyte particles. The positive electrode active material 1 and the electrolyte particles 2 are irregularly dispersed in the positive electrode mixture layer of the embodiment.

The positive electrode mixture is preferably prepared by mixing the active material substance and the electrolyte material in a mixing step and dispersing the electrolyte material in the positive electrode mixture. In this case, the electrolyte particles 2 passively cover the positive electrode active material 1 only by the amount that has naturally come into contact therewith in the mixing step, rather than actively cover the positive electrode active material.

In the embodiment, the active material substance is a positive electrode active material that is not coated or not covered with the phosphate solid electrolyte particles. The electrolyte material is in the form of particles of a solid electrolyte that does not coat or not cover the positive electrode active material. Where the production of the positive electrode mixture is completed, the positive electrode active material 1 and electrolyte particles 2 are present as shown in FIG. 1.

The example excluded from the embodiment includes a positive electrode material coated or covered with a phosphate solid electrolyte particles, or a solid electrolyte not coating with or not covering with the positive electrode active material. The example excluded from the embodiment is shown as below.

The example excluded from the embodiment includes: forming a thin film of a lithium-conducting material covering an active material, as described in JP 2003-173770 A; mixing the reaction materials of the electrolyte particles while applying mechanical energy, as described in the following comparative example, in order to produce a composite structure, and then forming electrolyte particles on the surface of the active material substance by heating; causing a positive electrode active material to include primary particles having a crystalline electrolyte as a mixed layer; producing a composite structure of a positive electrode active material and a solid electrolyte by using a centrifugal force; or discretely attaching solid electrolyte particles to the surface of positive electrode active material particles.

In the mixing step, the active material substance and electrolyte material, which are starting materials, are preferably mixed in a solvent. By mixing in a solvent, it is possible to disperse rapidly the electrolyte material and the active material substance, without actively covering the latter with the former.

It is undesirable that the active material substance and electrolyte material be premixed (powder mixing) with applying a shear force in a solvent-free state, prior to the mixing step. However, the electrolyte can be prevented from adhering to the active material, provided that the powder mixing is performed without applying a shear force.

Where the abovementioned step is provided, the electrolyte material discretely adheres to the active material substance. A method in which an electrolyte material is generated on the surface of the active material substance by producing a composite of reactive materials of the electrolyte material and the active material substance and performing heat treatment is also undesirable for similar reasons. Where a positive electrode mixture is produced with the electrolyte material being adhered to the active material substance, a state is reached in which the positive electrode active material 1 is covered by the electrolyte particles 2 as shown in FIG. 2.

Where the structure is obtained, as shown in FIG. 1, in which the positive electrode active material 1 and the electrolyte particles 2 are irregularly dispersed in the positive electrode mixture layer, without the former being actively covered by the latter, the increase in resistance on the positive electrode active material surface can be inhibited and a high operating voltage of the battery can be maintained. Thus, it is preferred that the electrolyte particles 2 and the positive electrode active material 1 be separated from each other in the positive electrode mixture layer. Further, due to the below-described action of the electrolyte particles 2 as an acid-consuming material, the elution of transition metal present in the positive electrode is inhibited, the decrease in capacity of the positive electrode and battery is unlikely to occur, and durability is increased.

A positive electrode active material to be selected as the active material substance is a material capable of storing and releasing lithium. The preferred examples of the positive electrode active material include lithium cobalt oxide (LiCoO₂), lithium manganese oxide (LiMn₂O₄), lithium nickel oxide (LiNiO₂), lithium nickel manganese oxide or lithium nickel cobalt manganese oxide, which are the mixtures thereof.

LiNi_{1/3}Co_{1/3}Mn_{1/3}O₂ is an example of a lithium nickel cobalt manganese oxide. In the embodiment, it is preferred that the below-described lithium nickel manganese oxide having a spinel structure be used. This active material is sometimes referred to hereinbelow as a NiMn spinel-system positive electrode active material.

For example, a lithium manganese nickel composite oxide represented by LiₓMn_{1.5}Ni_{0.5}O_{4-w} (0<x<2, 0≦w<2) is preferred, and LiNi_{0.5}Mn_{1.5}O₄ is particularly preferred as the NiMn spinel-system positive electrode active material. The transition metal sites in the LiNi_{0.5}Mn_{1.5}O₄ may include a substitution element such as Ti and Fe.

By selecting such a positive electrode active material, it is possible to increase the open-circuit voltage in the operation range of the battery to include a region equal to or higher than 4.3 V. As a result, the positive electrode may be a high-potential electrode.

Particles of phosphate solid electrolyte are preferred as a solid electrolyte to be selected as an electrolyte material. A phosphate solid electrolyte that reacts with acids and has an acid consumption function as an acid-consuming material is preferred.

The particularly preferred particles of phosphate solid electrolyte may be selected from particles such that when the particles are mixed with an acidic aqueous solution such as an aqueous solution of a strong acid, a large change in the pH of the aqueous solution is demonstrated after a predetermined period of time. The particles causing a large change in pH may be assumed to have the acid-consuming function. An aqueous solution of a strong acid such as hydrochloric acid may be used as the acidic aqueous solution.

For example, particles of a phosphate solid electrolyte of a predetermined particle diameter are mixed with 15 mL of 0.01N (pH 12) hydrochloric acid at a normal temperature of 25° C., the mixture is allowed to stay for 60 min, and the variation in pH of the hydrochloric acid is measured. The phosphate solid electrolyte particles suitable as the acid-consuming material cause a change in pH preferably greater than 0.05, more preferably equal to or greater than 4.35, and even more preferably equal to or greater than 9.57.

A phosphate solid electrolyte having lithium ion conductivity is preferred. Lithium-containing phosphates and also inorganic phosphates explained in the first embodiment can be advantageously used as the phosphate solid electrolyte.

Lithium phosphate (Li₃PO₄) and/or LAGP (Li_{1.5}Al_{0.5}Ge_{1.5}(PO₄)₃) is preferred, and lithium phosphate is particularly preferred as the lithium-containing phosphate.

Since such a solid electrolyte is resistant to a high voltage, it can be mixed in a positive electrode mixture. Therefore, as mentioned hereinabove, when the solid electrolyte is mixed in the positive electrode mixture, the electrolyte functions as the acid-consuming material, and the elution of metal from the active material caused by the reaction with acid in the electrolytic solution can be inhibited. As a result of selecting the abovementioned solid electrolyte, the durability of the battery increases.

The positive electrode mixture includes the solid electrolyte in the form of electrolyte, particles at a ratio preferably 0.5 wt % to 10.0 wt %, more preferably 1.0 wt % to 5.0 wt %, and particularly preferably 1.0 wt % to 3.0 wt % with respect to the positive electrode active material.

Where the content of the electrolyte particles in the positive electrode having the abovementioned structure is within the abovementioned range, the durability can be increased while inhibiting the increase in electric resistance even when the positive electrode is a high-potential electrode.

When PVDF is used as the positive electrode binder, an organic solvent is preferred as a solvent for the positive electrode. An aprotic polar solvent is further preferred. For example, NMP can be advantageously used. By using the solvent as a dispersant, it is possible to disperse rapidly the positive electrode material in the positive electrode mixture.

The positive electrode mixture is prepared by simultaneously adding the active material substance, electrolyte material, electrically conductive material, and binder to the solvent and kneading. The kneading is preferably performed by stirring and mixing for 2 hr with a planetary mixer after the abovementioned materials have been added to the solvent. The shear rate during stirring is preferably 35 rpm.

As mentioned hereinabove, it is not desirable that powder mixing (premixing) accompanied by shearing be performed separately, for example, with respect to the active material substance and electrolyte material. This is because, the solid electrolyte easily adheres to the positive electrode active material and forms a coating film.

The positive electrode of a lithium ion secondary battery is fabricated by coating the positive electrode mixture prepared in the above-described manner on the positive electrode collector and drying. Aluminum or an alloy containing aluminum as the main component may be used as the positive electrode collector.

The nonaqueous electrolytic solution is the same as that of the first embodiment. Where the abovementioned solvent is used for the nonaqueous electrolytic solution, it can be combined with the abovementioned high-potential electrode because of high resistance to acids. Such a solvent tends to generate an acid by thermal decomposition, but this problem can be resolved by using the solid electrolyte as the acid-consuming material. By using the positive electrode of the abovementioned configuration, it is possible to increase the durability of the battery while maintaining a high electrode potential.

The solid electrolyte may be mixed with the positive electrode mixture by coating at least part of the surface of the positive electrode active material with an inorganic solid electrolyte having lithium ion conductivity, as in the below-described Comparative Example 2. However, with such a method the battery resistance increases and battery output decreases in the same manner as in the above-described JP 2003-173770 A.

This is because the solid electrolyte actively coated on the active material surface causes the increase in positive electrode resistance. Thus, although the solid electrolyte has lithium ion conductivity, the conductivity is lower than that obtained with an electrolytic solution.

By contrast, in the embodiment the phosphate solid electrolyte particles are mixed as an acid-consuming material in the high-potential positive electrode mixture. Since the phosphate solid electrolyte particles are dispersed together with the positive electrode active material in the positive electrode mixture during mixing, the particles are not actively coated on the active material surface.

Since the particles consume the acid present in the high-potential positive electrode, the transition metal elution by the acid can be inhibited. Since the particles do not coat the positive electrode, the increase in resistance can be inhibited by contrast with the positive electrode such as described in JP 2003-173770 A. It is not always necessary that the solid electrolyte such as the phosphate solid electrolyte particles cover the positive electrode active material surface, and the solid electrolyte may be present close to the active material to inhibit the reaction thereof with the acid.

In the embodiment, it is possible to provide a lithium secondary battery that has high durability while operating at a high voltage. Further, in the embodiment, the production efficiency is high, since a preliminary process of coating the solid electrolyte on the positive electrode active material is not required.

The fabrication of a laminated cell will be explained below as an example of the invention.

Batteries fabricated as comparative examples and examples are described below. First, the selection of an acid-consuming material will is explained. Particles of the materials presented in Table 1 were mixed with 15 mL of 0.01 N (pH 12) hydrochloric acid and pH variations were measured. The variation amount between the pH of the materials after a period of time of 0 min, that is, prior to mixing, and the pH after a period of time of 60 min after mixing is taken as ΔpH. LAGP stands for Li_{1.5}Al_{0.5}Ge_{1.5}(PO₄)₃.

LiNi_{0.5}Mn_{1.5}O₄ which is a NiMn spinel according to Comparative Example 1, caused practically no changes in pH and the pH variation amount ΔpH was equal to or less than 0.05. Accordingly, it was decided that in this time interval, the NiMn spinel practically did not react with the acid.

TABLE 1

| | Material | 0 min | 60 min | ΔpH |
|---|---|---|---|---|
| Comparative | LiNi_{0.5}Mn_{1.5}O₄ | 1.98 | 2.03 | 0.05 |
| Example 1 | | | | |
| Example 1 | Li₃PO₄ | 1.98 | 11.55 | 9.57 |
| Example 2 | LAGP | 1.98 | 6.33 | 4.35 |

Meanwhile, lithium phosphate of Example 1 and LAGP of Example 2 changed the pH by 4.35 or more, thereby confirming the reaction with the acid. In particular, lithium phosphate demonstrated a pH variation amount as large as 9.57 and apparently had a powerful acid-consuming function. For this reason, lithium phosphate was used as a solid electrolyte for a positive electrode in the below-described example.

The preparation of a blended positive electrode will be explained below. The positive electrode mixtures or positive electrodes of Examples 3 to 7 and Comparative Examples 2 and 3 were prepared in the following manner. A slurry was prepared by mixing NiMn spinel (LiNi_{0.5}Mn_{1.5}O₄) as an active material substance, lithium phosphate as an electrolyte material, AB as an electrically conductive material, and PVDF as a binder in NMP as a solvent. The average particle diameter of the active material substance was 12 μm and the average particle diameter of the electrolyte material was 6.1 μm. The slurry was coated on an aluminum foil to form a positive electrode mixture layer and obtain a blended positive electrode.

As for compounding ratios, in Examples 3 to 7 and Comparative Examples 2 and 3, the electrically conducive material and the binder were used in amounts of 8 parts by mass and 3 parts by mass, respectively, per 89 parts by mass of the active material substance and electrolyte material. The compounding amount of the electrolyte material with respect to the active material weight is shown in Table 2. In Comparative Example 2, no electrolyte material was mixed.

The preparation of a coated positive electrode is explained below. The positive electrode mixture or positive electrode of Comparative Example 4 was prepared in the following manner. The materials were stirred and mixed using a powder mixer NOB-MINI manufactured by Hosokawa Micron Ltd. The shear speed during stirring was 35 rpm.

The materials to be stirred included LiNi_{0.5}Mn_{1.5}O₄ as an active material substance, and lithium nitrate (LiNO₃) and diammonium hydrogen phosphate (NH₄)HPO₄ as reaction materials for obtaining lithium phosphate. The compounding ratio was 0.89 part by mass of lithium nitrate and 0.50 part by mass of diammonium hydrogen phosphate per 89 parts by mass of the active material substance.

In Comparative Example 4, a composite was obtained by applying mechanical energy simultaneously with mixing the abovementioned materials. Then, heat treatment was conducted for 4 hr at 400° C. in the air. Lithium phosphate was produced in an amount of 0.5 part by mass per 89 parts by mass of active material substance from the lithium nitrate and diammonium hydrogen phosphate.

As a result of the above-described treatment, the surface of the positive electrode active material was covered by the electrolyte particles. Slurry was then prepared in the same manner as in Example 3, with the exception of mixing lithium phosphate as the electrolyte material, the slurry was coated to form a positive electrode mixture layer, and a coated positive electrode was obtained.

The preparation of the negative electrode is explained below. Graphite as an active material, CMC as a first binder (thickening agent), and SBR as a second binder were added at a compounding ratio of 98:1:1 to water as a solvent and mixed to prepare slurry. The negative electrode was obtained by coating the slurry on a copper foil.

The fabrication of a cell is explained below. The positive electrode and negative electrode prepared in the above-described manner and a three-layer coated separator in which PE was sandwiched between two layers of PP were laminated to produce a laminated cell. An electrolytic solution was prepared by dissolving lithium hexafluorophosphate (LiPF₆), which is a support salt, to a concentration of 1.0 M in a mixed solvent containing MFEC and DFDMC at a volume ratio 50:50. The conditioning was performed in the following manner: a cycle of charging to 4.9 V at a constant current of ⅓C, then allowing to stay for 10 min after discharging to 3.5 V at a constant current of ⅓C, and allowing to stay for 10 min was repeated 3 times.

The effects obtained in the comparative examples and examples are verified below. First, the initial IV resistance is verified. A battery charged to SOC 60% was subjected to discharge for 10 sec. at a temperature of 25° C. The discharge current rate was 1 C, 3 C, 5 C, 10 C, and the voltage was measured after discharging at each current rate. The average IV resistance was calculated from the current rate and voltage and taken as the initial IV resistance. The relationship between the mixed amount of solid electrolyte, mixing method, and initial IV resistance is shown in Table 2.

TABLE 2

| | | Solid | Capacity | Initial IV |
|---|---|---|---|---|
| | Positive | electrolyte | retention | resistance |
| | electrode | (wt %) | ratio (%) | (Ω) |
| Comparative | — | 0.0 | 69 | 1.4 |
| Example 2 | | | | |
| Example 3 | Blended | 0.5 | 80 | 2.1 |
| Example 4 | Blended | 1.0 | 85 | 2.0 |
| Example 5 | Blended | 3.0 | 86 | 2.1 |
| Example 6 | Blended | 5.0 | 83 | 2.3 |
| Example 7 | Blended | 10.0 | 77 | 2.3 |
| Comparative | Blended | 15.0 | 67 | 2.4 |
| Example 3 | | | | |
| Comparative | Coated | 0.5 | 79 | 3.0 |
| Example 4 | | | | |

The positive electrodes of Examples 3 to 7 were blended positive electrodes including 0.5 wt % to 10.0 wt % solid electrolyte in the positive electrode mixture layer. As shown in Table 2, the initial IV resistance of the batteries of Examples 3 to 7 was lower than that of Comparative Examples 3 and 4 and was below 2.4 Ω.

It follows from the above that the positive electrode mixture layer had a structure in which the solid electrolyte was dispersed in the mixing step, and when the solid electrolyte amount was in the certain range, the initial IV resistance of the battery employing the positive electrode decreased and the battery output increased despite the admixture of the solid electrolyte as an acid-consuming material.

The durability test is explained below. The fabricated battery was charged at a constant current to 4.9 V at 60° C. and then discharged to 3.5 V at a discharge rate of 2 C. The discharge capacity at this time was taken as the initial battery capacity. A cycle of charging to 4.9 V and then discharging to 3.5 V at a discharge rate of 2 C was then repeated a total of 200 times, and the discharge capacity in the 200-th cycle was taken as the post-test battery capacity. The capacity retention ratio (%) was determined by using the following equation.

Capacity retention ratio (%)=(Post-test battery capacity)/(Initial battery capacity)×100.

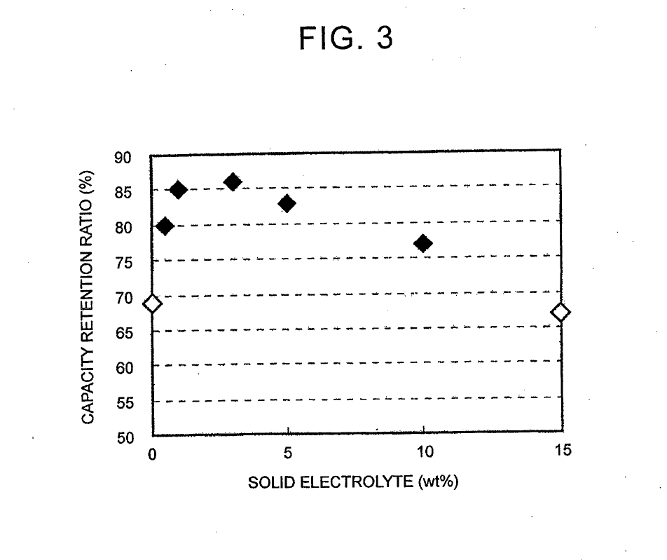

The relationship between the mixed amount of the solid electrolyte, mixing method, and capacity retention ratio is shown in FIG. 3 and Table 2. Date obtained in Examples 3 to 7 and Comparative Examples 2 and 3 are shown in FIG. 3. The positive electrode mixture layers of Examples 3 and 7 include the solid electrolyte in a range from 0.5 wt % to 10.0 wt %. The positive electrode mixture layers of Examples 4 to 6 include the solid electrolyte at 1.0 wt % to 5.0 wt %.

As shown in FIG. 3 and Table 2, since the positive electrodes of Examples 3 to 7 and Comparative Example 4 included the appropriate amounts of electrolyte particles, the capacity retention ratio increased over that of Comparative Example 2. The capacity retention ratio of the batteries of Examples 3 to 6 tended to increase even further by comparison with that of Comparative Examples 2 to 4 and exceeded 79%.

The comparison of the blended positive electrode of Example 3 and the coated positive electrode of Comparative Example 4 that used the same amount of lithium phosphate demonstrated that certain increase in durability and decrease in resistance could be realized by dispersing the solid electrolyte in the abovementioned mixing step.

In the coated positive electrode, the insertion and removal of lithium ions is inhibited by coating the active material surface, which becomes a major factor in increasing the resistance, whereas in the blended electrode, this problem has been resolved.

It follows from the above that in the battery of the embodiment, the durability of the battery could be increased in addition to reducing the initial IV resistance and increasing the battery output. The inventors have verified this effect with phosphates other than lithium phosphate, as described hereinbelow.

The application of other phosphates is explained below. Batteries of Examples 8 to 11 were fabricated by mixing phosphates including metals other than lithium (see Table 3) in the same manner as described above. Each phosphate was mixed at a ratio of 1.0 wt %, based on the weight of the respective active material. No phosphate was mixed in Comparative Example 2, in the same manner as hereinabove. In Example 4, lithium phosphate was mixed in the same manner as hereinabove.

TABLE 3

| | | Elution | Capacity retention |
|---|---|---|---|
| | Phosphate | ratio (%) | ratio (%) |
| Comparative | — | 0.113 | 64 |
| Example 2 | | | |
| Example 4 | Li₃PO₄ | 0.030 | 84 |
| Example 8 | Na₃PO₄ | 0.046 | 79 |
| Example 9 | K₃PO₄ | 0.091 | 69 |
| Example 10 | Mg(PO₄)₂ | 0.100 | 73 |
| Example 11 | Ca₃(PO₄)₂ | 0.093 | 72 |

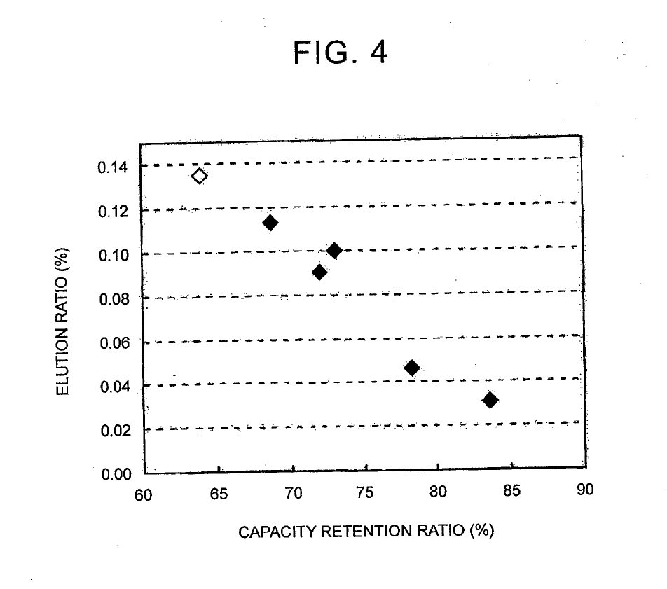

First, metal elution amount analysis is explained. The elution ratio (%) shown in FIG. 4 and Table 3 represents the amount of metal deposited on the negative electrode per unit volume of the negative electrode. This amount of metal apparently corresponds to the elution amount of metal (Ni+Mn) from the positive electrode active material. The amount of metal deposited on the negative electrode was measured by a plasma emission spectroscopy (ICP) after removing the negative electrode that has underwent the above-described cycle test from the battery. The capacity retention ratio was measured in the same manner as hereinabove.

As follows from FIG. 4 and Table 3, in Examples 4 and 8 to 11, the elution ratio decreased with respect to that of Comparative Example 2 because the positive electrode included electrolyte particles of the appropriate phosphate. Further, the capacity retention ratio in the batteries of Examples tended to increase over that of Comparative Example 2 and was equal to or higher than 69%.

The capacity retention ratio for Example 4 differs between Tables 2 and 3. This difference is within the range of assumable individual differences between the batteries. Tables 2 and 3 indicate that the capacity retention ratio in the batteries of the examples is maintained at a high level with good reproducibility.

The test results suggest that the phosphate present in the positive electrode, such as Li₃PO₄, decreases the elution of metal from the positive electrode active material by trapping the acid. Li₃PO₄ of Example 4 demonstrates particularly advantageous effect in reducing the elution of metal. Phosphates including an alkali metal belonging to third or fourth period or a second group element also demonstrate the effect of reducing the elution of metal, as shown in Examples 8 to 11.

Further, as shown in Tables 2 and 3, when the amount of the phosphate (electrolyte particles) is equal to or less than 10.0 wt % with respect to the positive electrode active material, a better effect of increasing the capacity retention ratio is demonstrated. When the electrolyte material is Li₃PO₄ or Na₃PO₄, as in Examples 4, and 8, the battery demonstrates a particularly advantageous capacity retention ratio.

As shown in FIG. 4, the relationship between the durability, that is, capacity retention ratio, and metal elution ratio was such that the elution ratio tended to increase with the increase in capacity retention ratio. The abovementioned test results suggest that the reduction in the elution of metal from the inorganic phosphate contributes to the increase in battery durability.

The invention is not limited to the configurations of the abovementioned embodiments or examples, and it goes without saying that the invention includes various changes, modifications and combinations that could be conceived of by a person skilled in the art within the scope of the invention.

1. A nonaqueous electrolyte secondary battery comprising:
a positive electrode having a positive electrode mixture layer;
a negative electrode; and
a nonaqueous electrolyte, wherein
the positive electrode mixture layer includes a positive electrode active material and an inorganic phosphate,
the inorganic phosphate is at least one of a phosphate and a pyrophosphate and includes at least one of alkali metals and second group elements,
the positive electrode mixture layer includes solid electrolyte particles of the inorganic phosphate; and
the solid electrolyte particles and the positive electrode active material are separated from each other in the positive electrode mixture layer.

2. The nonaqueous electrolyte secondary battery according to claim 1, wherein
the inorganic phosphate is the phosphate including one of the alkali metals and the second group elements.

3. The nonaqueous electrolyte secondary battery according to claim 2, wherein
the phosphate is Li₃PO₄.

4. The nonaqueous electrolyte secondary battery according to claim 2, wherein
the one of the alkali metals and the second group elements is an element belonging to one of the third period and fourth period.

5. The nonaqueous electrolyte secondary battery according to claim 4, wherein
the phosphate is Na₃PO₄.

6. The nonaqueous electrolyte secondary battery according to claim 1, wherein
the inorganic phosphate is Li_{1.5}Al_{0.5}Ge_{1.5}(PO₄)₃.

7. The nonaqueous electrolyte secondary battery according to claim 1, wherein a ratio of the inorganic phosphate to the positive electrode active material is 0.5 wt % to 10 wt %.

8. The nonaqueous electrolyte secondary battery according to claim 7, wherein the ratio of the inorganic phosphate to the positive electrode active material is 1.0 wt % to 5.0 wt %.

9. The nonaqueous electrolyte secondary battery according to claim 8, wherein the ratio of the inorganic phosphate to the positive electrode active material is 1.0 wt % to 3.0 wt %.

10. The nonaqueous electrolyte secondary battery according to claim 1, wherein
the positive electrode active material is a NiMn spinel-system positive electrode active material.

11. The nonaqueous electrolyte secondary battery according to claim 10, wherein
the NiMn spinel-system positive electrode active material is LiNi_{0.5}Mn_{1.5}O₄.

12-13. (canceled)

14. The nonaqueous electrolyte secondary battery according to claim 1, wherein
the inorganic phosphate is the phosphate including the alkali metal and the second group element.

15. The nonaqueous electrolyte secondary battery according to claim 1, wherein
the positive electrode has a region with an open-circuit voltage equal to or higher than 4.3 V (Li/Li⁺) in an operation range of the nonaqueous electrolyte secondary battery.
